(19) United States
(12) Patent Application Publication
(10) Pub. No.: US 2022/0067007 A1
(43) Pub. Date: Mar. 3, 2022

(54) SYSTEM AND METHOD FOR DETECTING RELEVANT SUBJECT ENTITIES IN VARIOUS DATABASES

(71) Applicant: Skyline AI Ltd., Tel Aviv-Yafo (IL)

(72) Inventor: Or HILTCH, Rishon LeZion (IL)

(73) Assignee: Skyline AI Ltd., Tel Aviv-Yafo (IL)

(21) Appl. No.: 17/113,689

(22) Filed: Dec. 7, 2020

Related U.S. Application Data
(63) Continuation-in-part of application No. 17/071,259, filed on Oct. 15, 2020, now Pat. No. 11,194,844.
(60) Provisional application No. 63/076,169, filed on Sep. 9, 2020.
(60) Provisional application No. 63/073,196, filed on Sep. 1, 2020.

(51) Int. Cl. G06F 16/215; G06N 20/00; G06F 16/2455

(52) U.S. Cl. CPC G06F 16/215; G06F 16/24556; G06N 20/00

(57) ABSTRACT

A method and system for detecting a relevant subject entity across different databases. A method includes determining relevance scores based on transaction data related to a potential participating entity and entity characteristics of subject entities, wherein each relevance score represents a relevance of a respective subject entity to the potential participating entity; identifying, based on the relevance scores, relevant subject entities for the potential participating entity; resolving the relevant subject entities between the transaction data and the subject entity data, wherein resolving the relevant subject entities includes applying resolution rules requiring at least matching a number of features between respective instances of the subject entity, wherein each subject entity is resolved such that respective instances of the subject entity are determined as uniquely identifying the same subject entity; identifying a redundant instance among the relevant subject entities; and removing the redundant instance from the plurality of relevant subject entities.

### CROSS-REFERENCE TO RELATED APPLICATIONS

This application claims the benefit of U.S. Provisional Patent Application No. 63/076,169 filed on Sep. 9, 2020. This application is also a continuation-in-part of U.S. patent application Ser. No. 17/071,259 filed on Oct. 15, 2020, now pending, which claims the benefit of U.S. Provisional Patent Application No. 63/073,196 filed on Sep. 1, 2020.

The contents of the above-referenced applications are hereby incorporated by reference.

### TECHNICAL FIELD

The present disclosure relates generally to entity resolution among different databases, and more specifically resolving entities in order to identify relevant subject entities.

### BACKGROUND

Although technological advances have been introduced in most industrial areas to improve efficiency and productivity, the real-estate domain currently requires a massive use of manual labor to perform tedious and costly steps. In some cases, it may be desirable for entities such as brokers and other interested parties to locate real estate properties that may be relevant for potential buyers. Such properties may include commercial real estate, multi-family houses, residential buildings, and the like.

Locating real estate properties that are relevant for a potential buyer among a wide range of potential real estate properties may be a complicated and time-consuming process. These potential real estate properties may be stored in multiple databases, making searching even more cumbersome. Presenting a potential buyer with irrelevant real estate properties may not only waste the potential buyer's time, but may also damage a relationship between the buyer and the broker who presents the offer because the buyer may place less trust in the broker's judgment.

Another challenge for presenting relevant properties to a buyer is caused by the need to accurately identify appearances of the same entity in different databases. Databases frequently store the same, similar, or otherwise related information as data in different formats. This is particularly true when different databases are maintained by different companies. As a result of these differences, entities may be inaccurately determined to be indistinct from each other. Consequently, redundant entries may be inadvertently provided to buyers. Further, if supplemental information related to a real estate property is needed, it is difficult to obtain such supplemental information without first accurately identifying the real estate property.

Solutions for providing accurate and efficient detection of real estate properties which are likely relevant for a potential buyer are desirable.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for detecting a relevant subject entity across different databases. The method comprises: determining a plurality of relevance scores based on transaction data related to a potential participating entity and entity characteristics of a plurality of subject entities indicated in subject entity data, wherein each relevance score represents a relevance of a respective subject entity to the potential participating entity; identifying, based on the plurality of relevance scores, a plurality of relevant subject entities for the potential participating entity among the plurality of subject entities; resolving the plurality of relevant subject entities between the transaction data and the subject entity data, wherein resolving the plurality of relevant subject entities further comprises applying resolution rules requiring at least matching a plurality of features between respective instances of the subject entity in the transaction data and in the subject entity data, wherein each subject entity is resolved such that respective instances of the subject entity in the transaction data and in the subject entity data are determined as uniquely identifying the same subject entity; identifying at least one redundant instance among the plurality of relevant subject entities based on the resolution of the plurality of relevant subject entities between the transaction data and the subject entity data; and removing the at least one redundant instance from the plurality of relevant subject entities to determine at least one unique relevant subject entity.

Certain embodiments disclosed herein also include a non-transitory computer readable medium having stored thereon causing a processing circuitry to execute a process, the process comprising: determining a plurality of relevance scores based on transaction data related to a potential participating entity and entity characteristics of a plurality of subject entities indicated in subject entity data, wherein each relevance score represents a relevance of a respective subject entity to the potential participating entity; identifying, based on the plurality of relevance scores, a plurality of relevant subject entities for the potential participating entity among the plurality of subject entities; resolving the plurality of relevant subject entities between the transaction data and the subject entity data, wherein resolving the plurality of relevant subject entities further comprises applying resolution rules requiring at least matching a plurality of features between respective instances of the subject entity in the transaction data and in the subject entity data, wherein each subject entity is resolved such that respective instances of the subject entity in the transaction data and in the subject entity data are determined as uniquely identifying the same subject entity; identifying at least one redundant instance among the plurality of relevant subject entities based on the resolution of the plurality of relevant subject entities between the transaction data and the subject entity data; and removing the at least one redundant instance from the plurality of relevant subject entities to determine at least one unique relevant subject entity.

Certain embodiments disclosed herein also include a system for detecting a relevant subject entity across different databases. The system comprises: a processing circuitry; and a memory, the memory containing instructions that, when executed by the processing circuitry, configure the system to: determine a plurality of relevance scores based on transaction data related to a potential participating entity and entity characteristics of a plurality of subject entities indicated in subject entity data, wherein each relevance score represents a relevance of a respective subject entity to the potential participating entity; identify, based on the plurality of relevance scores, a plurality of relevant subject entities for the potential participating entity among the plurality of subject entities; resolve the plurality of relevant subject entities between the transaction data and the subject entity data, wherein resolving the plurality of relevant subject entities further comprises applying resolution rules requiring at least matching a plurality of features between respective instances of the subject entity in the transaction data and in the subject entity data, wherein each subject entity is resolved such that respective instances of the subject entity in the transaction data and in the subject entity data are determined as uniquely identifying the same subject entity; identify at least one redundant instance among the plurality of relevant subject entities based on the resolution of the plurality of relevant subject entities between the transaction data and the subject entity data; and remove the at least one redundant instance from the plurality of relevant subject entities to determine at least one unique relevant subject entity.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various embodiments.

FIG. 2 is a schematic diagram of a relevance identifier according to an embodiment.

FIG. 3 is a flowchart illustrating a method for identifying a relevant subject entity for a potential participating entity according to an embodiment.

FIG. 4 is a flowchart illustrating a method for resolving entities between databases according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include systems and methods for identifying relevant subject entities in various databases. The disclosed embodiments allow for identifying subject entities which are likely to be of interest to a potential participating entity. The potential participating entity is an entity who has previously engaged in transactions involving subject entities and who may be interested in conducting transactions to acquire (or acquire interest in) subject entities that are relevant to them.

Based on transaction data related to the potential participating entity and entity characteristics of a set of potentially relevant subject entities, relevance scores are determined for the potentially relevant subject entities. The relevance scores may be determined using a machine learning model trained based on training subject entity data and training entity characteristics. One or more relevant subject entities for the potential participating entity are identified based on the relevance scores. In some embodiments, only subject entities having a relevance score above a threshold are identified as relevant.

In an embodiment, redundant subject entities are removed from among the identified relevant subject entities. To this end, the relevant subject entities are resolved in order to uniquely identify each relevant subject entity among the transaction data and characteristics of subject entities, and any redundant instances of relevant subject entities are removed.

In this regard, it has been identified that, data related to transactions and data related to specific real estate properties may be stored in different formats, which can cause information such as address, description, or other features of the same property to appear differently in different databases. More specifically, in real estate, there are no globally unique identifiers used for properties in different databases. Manually evaluating whether two data entries representing properties in fact represent the same underlying property therefore often requires a subjective evaluation of whether the data entries are “close enough.” Differences in database formatting may cause redundant instances of the same entity to be inaccurately identified as different entities. Presenting such redundant results to users unnecessarily utilizes network bandwidth needed to communicate such results and may cause user disengagement due to lack of trust regarding accuracy of results. The disclosed embodiments provide a rules-based approach which considers various data points in order to uniquely identify entities regardless of particular formatting, thereby allowing for an objective analysis which improves consistency and accuracy of results.

In an embodiment, resolving the entities includes applying resolution rules to data of each entity. The resolution rules include rules for uniquely identifying an entity regardless of original format. Accordingly, the disclosed embodiments provide a rules-based system for resolving entities to be used in identifying relevant subject entities.

In a further embodiment, supplemental transaction data may be identified by resolving instances of subject entities indicated in transaction data and in subject entity data. Subject entities indicated in a first database storing transaction data related to the potential participating entity and in one or more second databases of subject entity data are resolved in order to uniquely identify instances of each subject entity in each database. Data related to the resolved subject entities are extracted from the second databases.

Extracting such supplemental data allows for more accurately determining relevance scores and, consequently, more accurately identifying relevant subject entities. In this regard, it has been identified that transaction data often only provides partial information about a particular real estate property such that the characteristics of the property which made it desirable to the buyer may not be included in the transaction data and, accordingly, the accuracy of identifying relevant subject entities based on such transaction data may be lower than if more data was available. However, as noted above, there is no standard formatting for databases storing real estate data. Thus, resolving subject entities as described herein allows for accurately identifying instances of a subject entity in different databases in order to find appropriate supplemental data which, in turn, allows for more accurately identifying relevant subject entities.

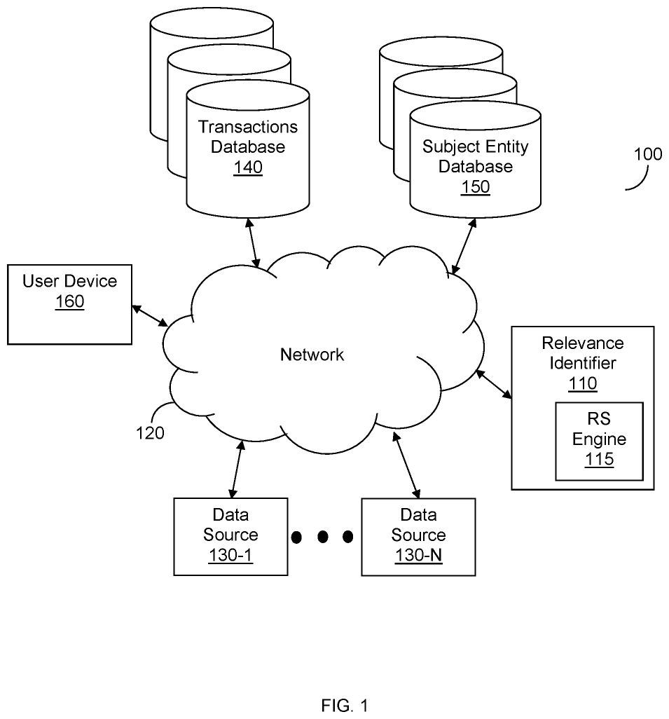

FIG. 1 is an example network diagram 100 utilized to describe the disclosed embodiments. In the network diagram 100, a relevance identifier 110 communicates with data sources 130-1 through 130-N via a network 120. The network 120 may be the Internet, the world-wide-web (WWW), a local area network (LAN), a wide area network (WAN), a metro area network (MAN), combinations thereof, and the like.

The plurality of data sources 130-1 through 130-N (hereinafter referred to as a data source 130 or data sources 130 for simplicity) store data related to characteristics of potential participating entities such as potential buyers. The data sources 130 may include public or private websites, such as real estate related websites, similar web sources, and the like.

The transactions databases 140 store transaction data related to transactions involving transfer of part or all of the interest in a subject entity. In particular, such transaction data includes identifiers of the buyer, seller, and the subject entity being transferred in each transaction. The transaction data may further include parameters related to the transaction such as, but not limited to, sale price.

The subject entity databases 150 store subject entity data for various subject entities. The subject entity data may include, but is not limited to, identifiers of subject entities, addresses, price, location, size, number of units, occupancy, socioeconomic status in the area, job opportunities, combinations thereof, and the like.

Each of the transactions databases 140 and the subject entity databases 150 may be, but is not limited to, a data warehouse, a cloud database, governmental databases, and the like.

According to the disclosed embodiments, the relevance identifier 110 is configured to extract and analyze data for detecting one or more relevant subject entities for a potential participating entity. Such relevant subject entities may include, but are not limited to, commercial real estate, multi-family houses, residential buildings, and the like. A potential participating entity is a potential buyer or other entity who may wish to purchase or rent a relevant subject entity. A relevant subject entity for a potential participating may be a property having particular characteristics that are required by the potential buyer. For example, a potential buyer may find a certain real estate property as relevant or irrelevant based on the property's location, size, number of units, occupancy, socioeconomic status in the area, job opportunities, and the like.

In an embodiment, the relevance identifier 110 receives a request to detect at least one subject entity that is relevant for at least a potential participating entity having a first set of characteristics. The request may be an electronic request sent from a user device such as personal computer (PC), laptop, smartphone, etc. A potential participating entity may be, for example, a private company, a public company, an individual, a non-profit entity, and the like.

A subject entity may be relevant for a potential participating entity based on several parameters as further discussed below. More specifically, characteristics of the potential participating entity may indicate whether the potential participating entity is a private or public company, the number of employees, the identity of the company's chief executive officer (CEO), financial performances, and the like. These characteristics may be pertinent to preferences of the potential participating entity and may therefore be utilized as a factor in determining relevance scores for given subject entities with respect to the potential participating entity. The request may be received from a user device 160 that is associated with an entity (e.g., a person, a broker, a company, etc.) that wishes to offer, to a specific potential participating entity (e.g., a specific potential buyer), one or more real estate properties that may be relevant for the specific potential participating entity.

The relevance identifier 110 is configured to collect a first dataset of historical transaction data of the potential participating entity. Historical transaction data may be indicative of types of real estate properties usually purchased or rented by the potential participating entity, properties' locations, prices, number of units, real estate properties the potential buyer recently sold, and the like. The first dataset may be extracted from a data source (e.g., the data source 130-1), a database (e.g., the database 140), or both. That is, some of the transaction data may be previously gathered and stored in a database from which the data may be extracted, and some of the real estate transaction history may be gathered by searching through one or more data sources, e.g., real estate websites.

The relevance identifier 110 is also configured to collect a second dataset including subject entity data for other subject entities. Each of the other subject entities is associated with respective subject entity characteristics (i.e., a second set of characteristics). The other subject entities may include properties that are currently for sale, properties that are not (off-market properties), or both. The second dataset may be extracted from one or more data sources (e.g., the data source 130-1). The second set of characteristics may include, but is not limited to, prices, locations, number of units, occupancy, and so on.

The relevance identifier 110 may also be configured to collect a third dataset that includes the abovementioned characteristics of the potential participating entity. The third dataset may be extracted from a database (e.g., the database 140), a data source (e.g., the data source 130-1), and the like.

In an embodiment, the relevance identifier 110 is configured to apply a model to the first dataset, the second dataset, and the third dataset. The model, such as a machine learning algorithm, is adapted to determine a relevance score for each of a plurality of subject entities with respect to the potential participating entity. To this end, in a further embodiment, the relevance identifier 110 may be further configured with a relevance score (RS) engine 115 configured to determine relevance scores as described herein.

Each relevance score may represent a probability that the subject entity is relevant to the potential participating entity's transactional interests. As a non-limiting example, a relevance score may be a number from “1” to “5”, where “1” represents the lowest probability that the subject entity is relevant to a particular potential participating entity and “5” represents the highest probability that the subject entity is relevant to a particular potential participating entity.

In an embodiment, only subject entities having relevance scores above a threshold are identified as relevant. The threshold value may be, for example, a predetermined value of “4” such that every subject entity having a probability score that is equal to or larger than “4” is relevant to a particular potential participating entity.

As a non-limiting example, the algorithm receives as an input the first dataset indicating that the potential buyer has bought 30 real estate properties in Florida over the last two years and that the price of 90% of the properties was between 4-5 million dollars. The third dataset indicating that the potential buyer is a private company that operates mainly in Florida, Unites States. The second dataset provides information regarding 20,000 real estate that may be for sale, off-market, or that may be in a “soon to market” status (which means that there is indication that the real estate property will be offered for sale soon). By applying the model to the collected datasets, only five real estate properties having relevance scores above the predetermined threshold value are identified as relevant for the potential buyer. It should be noted that, in order to provide an accurate probability score, multiple characteristics may be analyzed. That is, it may be desirable to analyze as many characteristics as possible in order to accurately predict what would be a relevant real estate property for a specific potential buyer. As noted above, additional characteristics which may be analyzed may include price, location, occupancy, number of units, size, socioeconomic status in the area, job opportunities, and the like.

In an embodiment, the relevance identifier 110 is configured to generate a notification upon identifying one or more relevant subject entities. The electronic notification may be a message or any other electronic notice. The electronic notification may include, but is not limited to, a recommendation to offer the potential buyer a specific real estate property having a relevance score that is above the predetermined threshold value. The electronic notification may also include a description of the reasons (e.g., parameters) that caused a certain subject entity to be classified as a relevant for the specific potential participating entity. As a non-limiting example, the notification may indicate that a specific real estate property has been associated with the highest possible relevance score to be relevant for the potential buyer based on ten different parameters (and show the ten parameters in the notifications). In an embodiment, the relevance identifier 110 may be configured to send the electronic notification to a predefined computerized source, such as, a server, an end-point device (e.g., the user device 160), and the like.

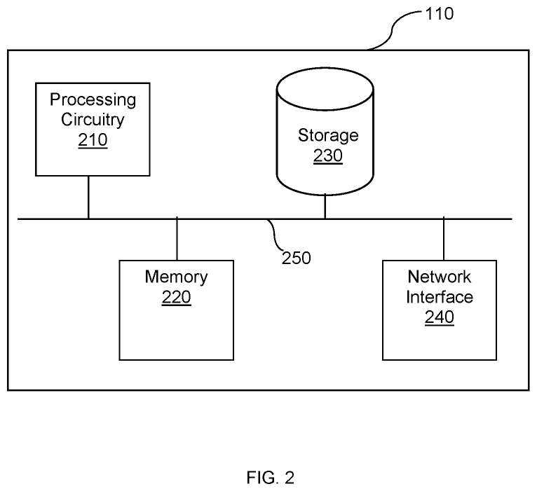

FIG. 2 is an example schematic diagram of the relevance identifier 110 according to an embodiment. The relevance identifier 110 includes a processing circuity 210 coupled to a memory 220, a storage 230, and a network interface 240. In an embodiment, the components of the relevance identifier 110 are connected by a communication bus 260.

The processing circuity 210 may be realized by one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), and the like, or any other hardware logic components that can perform calculations or other manipulations of information. The memory 115 may be volatile (e.g., RAM,), non-volatile (e.g., ROM, flash memory, and the like), or a combination thereof.

The storage 230 may be magnetic storage, optical storage, solid state storage, and the like and may be realized, for example, as flash memory or other memory technology, CD-ROM, DVDs or other optical storage, magnetic cassettes, magnetic tape, magnetic disk storage or other magnetic storage devices, or any other medium which can be used to store the desired information.

In one configuration, computer readable instructions to implement one or more embodiments disclosed herein may be stored in the storage 230. The storage 230 may also store other computer readable instructions to implement an operating system, an application program, and the like. Computer readable instructions may be loaded in the memory 220 for execution by the processing circuitry 210.

In another embodiment, the storage 230, the memory 220, or both, are configured to store software. Software shall be construed broadly to mean any type of instructions, whether referred to as software, firmware, middleware, microcode, or hardware description language. Instructions may include code (e.g., in source code format, binary code format, executable code format, or any other suitable format of code). The instructions cause the processing circuity 210 to perform the various functions described herein.

The network interface 240 allows the relevance identifier 110 to communicate with external sources. For example, the network interface 240 may be configured to access or communicate with a network or various data sources.

In an embodiment, the network interface 240 allows remote access to the relevance identifier 110 for the purpose of, for example, configuration, reporting, and the like. The network interface 240 may include a wired connection or a wireless connection. The network interface 240 may transmit communication media, receive communication media, or both. For example, the network interface 240 may include a modem, a network interface card (NIC), an integrated network interface, a radio frequency transmitter/receiver, an infrared port, a USB connection, and the like.

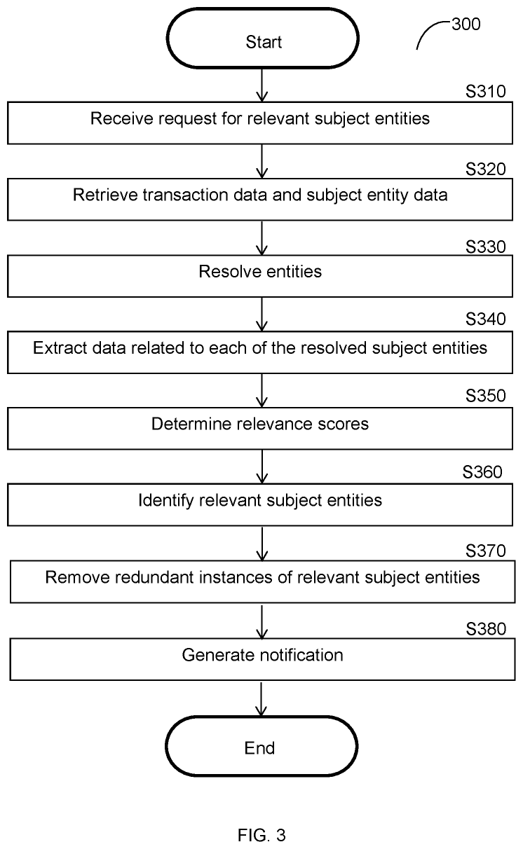

FIG. 3 is an example flowchart 300 illustrating a method for identifying relevant subject entities according to an embodiment. In an embodiment, the method is performed by the relevance identifier 110, FIG. 1.

At S310, a request for subject entities which might be relevant to a particular potential participating entity is received. The request may be for a subject entity such as, but not limited to, a real estate property. The potential participating entity may be, but is not limited to, a private company, a public company, an individual, and the like.

The request may further include characteristics of the potential participating entity. Alternatively, or collectively, the request may include an identifier of the potential participating entity. To this end, in some embodiments, S310 may further include retrieving data indicating characteristics of the potential participating entity.

At S320, transaction data related to the potential participating entity and subject entity data related to a set of first subject entities are retrieved from a database. The transaction data may be stored in a first database and the subject entity data may be stored in one or more second databases.

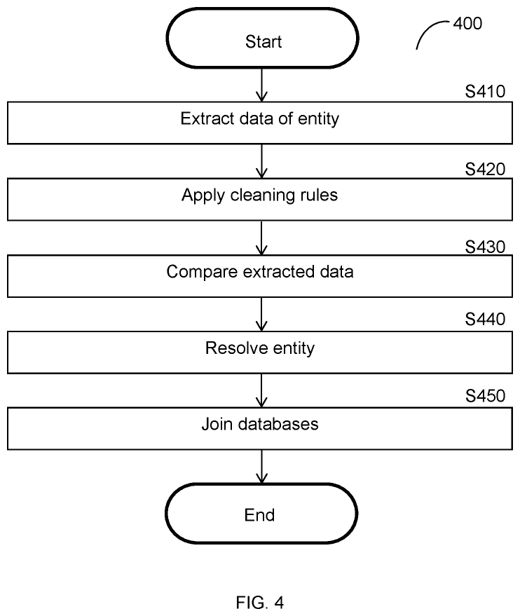

At optional S330, the subject entities in the transaction data and subject entity data are resolved in order to uniquely identify each subject entity that is indicated in both the transaction data and the subject entity data. In an embodiment, S330 includes resolving each subject entity indicated in the transaction data and in the subject entity data. In a further embodiment, such resolution is performed as described below with respect to FIG. 4. More specifically, an instance of each subject entity in the transaction data may be compared to instances of subject entities in the subject entity data, thereby uniquely identifying the subject entity in both of the datasets.

At optional S340, data related to each of the resolved subject entities that was determined to be in both the transaction data and in the subject entity data at S330 is extracted. The extracted data includes the subject entity data for each subject entity that was in both datasets. In an embodiment, S340 includes enriching the transaction data using the extracted data. As noted above, transaction data is often incomplete such that accurately identifying relevant supplemental data in different data sources and enriching the transaction data using that supplemental data allows for more accurately identifying relevant subject entities.

At S350, a relevance score is determined for each subject entity among multiple subject entities based on the transaction data and subject entity data indicating the multiple subject entities. Each relevance score indicates a probability that the respective subject entity is relevant to the potential participating entity (i.e., potential purchasing entity). When subject entities among the transaction data are resolved at S330 and data related to those resolved entities is extracted at S340, the relevance score is determined based on the enriched transaction data as described above.

In an embodiment, S350 includes applying a relevance model to the extracted data of the subject entities and to data which may be indicative of transaction preferences of the potential participating entity. Data which may be indicative of transaction preferences of the potential participating entity may include, but is not limited to, the transaction data, one or more buyer characteristics, both, and the like. In an embodiment, the relevance model is a machine learning model trained using training subject entity data and training transaction preference data.

At S360, one or more relevant subject entities are identified for the potential participating entity based on the relevance scores. In an embodiment, subject entities having relevance scores above a threshold are identified as relevant to the potential participating entity.

At S370, redundant instances among the relevant subject entities are removed. In an embodiment, S370 includes resolving the instances among the identified relevant subject entities as described below with respect to FIG. 4. By resolving the instances of the relevant subject entities, those relevant subject entities can be uniquely identified such that any duplicate instances are accurately determined as redundant and removed.

At S380, a notification is generated based on the relevant subject entities. The notification may include, but is not limited to, a recommendation to offer the potential participating entity one or more of the relevant subject entities. The notification may further include a description of the reasons (e.g., the parameters among the analyzed data) that caused a certain subject entity to be classified as a relevant for the specific potential participating entity. Such reasons may be identified based on, for example, weights of the model and values of the respective parameters. For example, when a portion of the model as applied to a parameter yields a weighted value above a threshold, the parameter may be identified as a reason as to why the subject entity is relevant.

FIG. 4 is a flowchart 400 illustrating a method for resolving entities according to an embodiment. In an embodiment, the method is performed by the relevance identifier 110, FIG. 1.

At S410, data related to the entity is extracted from a first database. More specifically, the extracted data includes data that is relevant to uniquely identifying the entity. The uniquely identifying data may include, but is not limited to, name, address, location, size, occupancy features (e.g., potential number of occupants, number of bedrooms, etc.), combinations thereof, and the like.

At S420, resolution rules for cleaning the extracted data are applied. Such cleaning resolution rules may include, but are not limited to, rules for removing common postfixes, rules for cleaning text (e.g., stripping spaces from text, converting uppercase to lowercase, etc.), rules for removing honorifics or titles from names, rules for removing common postfixes (e.g., “LLC,” “Ltd.,” “Inc.,” etc.), combinations thereof, and the like. Such cleaning resolution rules provide rules for determining whether features which otherwise do not match reflect the same underlying features.

At S430, the extracted data is compared to data related to one or more entities indicated in a second database. In an embodiment, S430 may include identifying matching features between the instance of the entity in the first database and the data in the second database.

At S440, the entity is resolved based on the comparison. In an embodiment, resolving the entity includes identifying any instances of the entity in the second database. The entity resolution is performed using resolution rules that collectively define whether two instances of data representing entities effectively represent the same uniquely identified entity. The resolution rules provide rules accounting for multiple factors that collectively uniquely identify a particular entity, and different resolution rules may be utilized for different types of entities. To this end, in an embodiment, S440 may include determining a type of entity to be resolved and applying appropriate resolution rules for that type of entity.

The resolution rules collectively define requirements for uniquely identifying the entity in different datasets and may include, but are not limited to, requirements for a number of matching features. More specifically, the resolution rules require matching between multiple features included in different instances of entities in order to identify those instances as representing the same underlying entity. Each instance of an entity may be an entry in a database or other data source indicating information that may be related to an entity. In an embodiment, S440 includes applying such resolution rules to determine whether instances of entities in the first and second databases represent the same underlying entity.

By using resolution rules requiring multiple matching features, an entity can be uniquely identified as existing in different databases despite any differences in format or specific features. As a non-limiting example, rather than solely relying on address to identify an entity, multiple features including number of units, vintage, latitude and longitude, and the like, may be utilized to determine whether two instances of entities represent the same entity. Further, by cleaning the data as noted above with respect to S420, individual features are more likely to be matched accurately despite common differences in formatting.

In this regard, it is noted that manual resolution of entities in databases is infeasible due to the sheer volume of entries. Regardless, manual resolution of entities requires subjective evaluations regarding entity similarity as expressed in different databases. As a result, different human observers may come to different conclusions as to whether different instances of entities represent the same underlying entity. More specifically, such manual resolution of entities may involve subjectively determining whether names, addresses, or descriptions of entities “feel” sufficiently similar, which may cause some human observers to determine that two instances of entities represent the same underlying entity while other human observers determine that the instances represent different underlying entities. The resolution rules provide an objective set of rules which provide consistent and accurate results as compared to manual entity resolution.

It has further been identified that, aside from formatting differences, data related to an entity may include minor errors which may have a significant impact on whether the data “appears” to represent the same entity from the perspective of a manual observer. For example, one instance of an entity may mistakenly indicate an address of “123 ABC Street” when the address of the actual entity is “125 ABC Street.” A human observer may or may not recognize that these instances represent the same underlying real estate property. The resolution rules, which utilize multiple rules defining minimum requirements for matching entities, provide a mechanism for uniquely identifying an entity regardless of such mistakes or other differences.

The resolution rules may further include rules for determining whether specific features of entities match such as, but not limited to, rules defining abbreviations, rules defining synonyms, rules defining partial matches, and the like. As a non-limiting example, an address may appear in one database as “123 Fannie Road” and in another database as “123 Fannie Rd,” and the resolution rules may define “Rd” as an abbreviation of “Road” such that these entries would match. As another non-limiting example, resolution rules defining partial matches may indicate that an address partially matches if either the number of the address (e.g., “123”) or the named portion of the address (e.g., “Fannie Road”) matches but the other does not match.

At optional S450, the databases storing the resolved entity may be joined. In an embodiment, S450 includes performing a JOIN operation between the databases. In a further embodiment, S450 further includes storing or updating a table mapping instances of the entity to each other such that the instances are effectively marked as being instances of the same entity. Joining the databases allows for designating different instances of entities as the same, thereby avoiding redundant resolution of entities between the two databases.

It should be noted that FIG. 4 is described with respect to resolving entities between different databases for simplicity purposes, but that entities may be equally resolved between datasets or other organizations of data without departing from the scope of the disclosure.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

1. A method for detecting a relevant subject entity across different databases, comprising:
determining a plurality of relevance scores based on transaction data related to a potential participating entity and entity characteristics of a plurality of subject entities indicated in subject entity data, wherein each relevance score represents a relevance of a respective subject entity to the potential participating entity, wherein the plurality of relevance scores is determined using a machine learning model trained based on training subject entity data and training entity characteristics;
identifying, based on the plurality of relevance scores, a plurality of relevant subject entities for the potential participating entity among the plurality of subject entities;
resolving the plurality of relevant subject entities between the transaction data and the subject entity data, wherein resolving the plurality of relevant subject entities further comprises applying resolution rules requiring at least matching a plurality of features between respective instances of the subject entity in the transaction data and in the subject entity data, wherein each subject entity is resolved such that respective instances of the subject entity in the transaction data and in the subject entity data are determined as uniquely identifying the same subject entity;
identifying at least one redundant instance among the plurality of relevant subject entities based on the resolution of the plurality of relevant subject entities between the transaction data and the subject entity data; and
removing the at least one redundant instance from the plurality of relevant subject entities among the transaction data to determine at least one unique relevant subject entity.

2. The method of claim 1, wherein each relevant subject entity has a respective relevance score above a threshold.

3. (canceled)

4. The method of claim 1, wherein the resolution rules include cleaning resolution rules for cleaning data related to entities.

5. The method of claim 4, wherein the cleaning resolution rules include rules for removing predetermined postfixes.

6. The method of claim 1, wherein the resolution rules include requirements for a minimum number of matching features.

7. The method of claim 1, wherein the plurality of relevance scores is determined based further on a plurality of characteristics of the potential participating entity.

8. The method of claim 1, further comprising:
resolving the plurality of subject entities between a first database and at least one second database, wherein the first database stores the transaction data related to the potential participating entity, wherein the at least one second database stores subject entity data, wherein each subject entity is resolved such that respective instances of each subject entity in both the first database and the at least one second database are determined as each uniquely identifying the same subject entity, wherein resolving each subject entity further comprises applying resolution rules requiring at least matching a plurality of features between respective instances of the first entity;
extracting subject entity data from the at least one second database based on the resolution of the plurality of subject entities; and
enriching the transaction data using the extracted subject entity data.

9. The method of claim 1, further comprising:
generating a notification based on the at least one relevant subject entity; and
sending the notification to a user device.

10. A non-transitory computer readable medium having stored thereon instructions for causing a processing circuitry to execute a process, the process comprising:
determining a plurality of relevance scores based on transaction data related to a potential participating entity and entity characteristics of a plurality of subject entities indicated in subject entity data, wherein each relevance score represents a relevance of a respective subject entity to the potential participating entity, wherein the plurality of relevance scores is determined using a machine learning model trained based on training subject entity data and training entity characteristics;
identifying, based on the plurality of relevance scores, a plurality of relevant subject entities for the potential participating entity among the plurality of subject entities;
resolving the plurality of relevant subject entities between the transaction data and the subject entity data, wherein resolving the plurality of relevant subject entities further comprises applying resolution rules requiring at least matching a plurality of features between respective instances of the subject entity in the transaction data and in the subject entity data, wherein each subject entity is resolved such that respective instances of the subject entity in the transaction data and in the subject entity data are determined as uniquely identifying the same subject entity;
identifying at least one redundant instance among the plurality of relevant subject entities based on the resolution of the plurality of relevant subject entities between the transaction data and the subject entity data; and
removing the at least one redundant instance from the plurality of relevant subject entities among the transaction data to determine at least one unique relevant subject entity.

11. A system for detecting a relevant subject entity across different databases, comprising:
a processing circuitry; and
a memory, the memory containing instructions that, when executed by the processing circuitry, configure the system to:
determine a plurality of relevance scores based on transaction data related to a potential participating entity and entity characteristics of a plurality of subject entities indicated in subject entity data, wherein each relevance score represents a relevance of a respective subject entity to the potential participating entity, wherein the plurality of relevance scores is determined using a machine learning model trained based on training subject entity data and training entity characteristics;
identify, based on the plurality of relevance scores, a plurality of relevant subject entities for the potential participating entity among the plurality of subject entities;
resolve the plurality of relevant subject entities between the transaction data and the subject entity data, wherein resolving the plurality of relevant subject entities further comprises applying resolution rules requiring at least matching a plurality of features between respective instances of the subject entity in the transaction data and in the subject entity data, wherein each subject entity is resolved such that respective instances of the subject entity in the transaction data and in the subject entity data are determined as uniquely identifying the same subject entity;
identify at least one redundant instance among the plurality of relevant subject entities based on the resolution of the plurality of relevant subject entities between the transaction data and the subject entity data; and
remove the at least one redundant instance from the plurality of relevant subject entities among the transaction data to determine at least one unique relevant subject entity.

12. The system of claim 11, wherein each relevant subject entity has a respective relevance score above a threshold.

13. (canceled)

14. The system of claim 11, wherein the resolution rules include cleaning resolution rules for cleaning data related to entities.

15. The system of claim 14, wherein the cleaning resolution rules include rules for removing predetermined postfixes.

16. The system of claim 11, wherein the resolution rules include requirements for a minimum number of matching features.

17. The system of claim 11, wherein the plurality of relevance scores is determined based further on a plurality of characteristics of the potential participating entity.

18. The system of claim 11, wherein the system is further configured to:
resolve the plurality of subject entities between a first database and at least one second database, wherein the first database stores the transaction data related to the potential participating entity, wherein the at least one second database stores subject entity data, wherein each subject entity is resolved such that respective instances of each subject entity in both the first database and the at least one second database are determined as each uniquely identifying the same subject entity, wherein resolving each subject entity further comprises applying resolution rules requiring at least matching a plurality of features between respective instances of the first entity;
extract subject entity data from the at least one second database based on the resolution of the plurality of subject entities; and
enrich the transaction data using the extracted subject entity data.

19. The system of claim 11, further comprising:
generate a notification based on the at least one relevant subject entity; and
send the notification to a user device.
